(19) United States
(12) Patent Application Publication
(10) Pub. No.: US 2025/0142421 A1
(43) Pub. Date: May 1, 2025

(54) PREDICTIVE APPLICATION CONTEXT RELOCATION

(71) Applicant: Lenovo (Singapore) Pte. Ltd., New Tech Park (SG)

(72) Inventors: Emmanouil Pateromichelakis, Viersen (DE); Dimitrios Karampatsis, Ruislip (GB)

(21) Appl. No.: 18/685,140

(22) PCT Filed: Sep. 28, 2021
(86) PCT No.: PCT/EP2021/076698

§ 371 Date: Feb. 20, 2024

(30) Foreign Application Priority Data
Aug. 19, 2021 (GR) 20210100560

(51) Int. Cl. H04W 36/00; H04L 67/00; H04W 84/04

(52) U.S. Cl. CPC H04W 36/0033; H04L 67/34; H04W 84/042

(57) ABSTRACT

Various aspects of the present disclosure relate to predictive application context relocation. One apparatus is configured to receive a predicted route for a user equipment (“UE”), receive one or more data analytics parameters for at least one of a radio access network, a core network, or an edge data network associated with the predicted route of the UE, determine at least one predictive trigger action for remapping an application client from a first edge application server of a first edge data network to a second edge application server of a second edge data network based on the predicted route for the UE and the one or more data analytics parameters, and determine an application context relocation for the application client based on the at least one trigger action.

### FIELD

The subject matter disclosed herein relates generally to wireless communications and more particularly relates to predictive application context relocation.

### BACKGROUND

In certain wireless communication systems, a User Equipment device (“UE”) is able to connect with a fifth-generation (“5G”) core network (i.e., “5GC”) in a Public Land Mobile Network (“PLMN”). In mobile edge cloud deployments, one key aspect is the portability and migration of edge applications to different edge application servers (“EAS”), while maintaining the edge service continuity.

### BRIEF SUMMARY

Disclosed are procedures for predictive application context relocation. Said procedures may be implemented by apparatus, systems, methods, and/or computer program products.

In one embodiment, a first method includes receiving, at a mobile edge computing function of a mobile wireless communication network from an application, a predicted route for a user equipment (“UE”) device. In further embodiments, the first method includes receiving, at the mobile edge computing function from at least one data analytics service producer, data analytics parameters for at least one of a radio access network, a core network, and an edge data network associated with the predicted route of the UE. In one embodiment, the first method includes determining at least one predictive trigger action for remapping an application client (“AC”) from a first edge application server of a first edge data network to a second edge application server of a second edge data network based on the predicted route for the UE and the data analytics parameters. In certain embodiments, the first method includes determining a planned predictive application context relocation for the AC from the first edge application server of the first edge data network to the second edge application server of the second edge data network based on the trigger action.

In one embodiment, a second method includes receiving, at a network function of a mobile wireless communication network, a predicted route for a user equipment (“UE”) device, translating the predicted route for the UE device to at least one service cell that the UE device is expected to traverse, receiving, at the network function, network data analytics parameters for at least one data network associated with the predicted route of the UE and radio measurements describing cell radio conditions for the at least one service cell along the predicted route for the UE device, determining a planned predictive application context relocation for an application client (“AC”) from a first edge application server to a second edge application server based on a trigger action, and transmitting the planned predictive application context relocation to at least one entity involved in the application context relocation for the AC.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for predictive application context relocation;

FIG. 2 depicts one embodiment of a procedure flow for predictive ACR from the application side/middleware;

FIG. 3 depicts one embodiment of a procedure flow for predictive ACR from the network side;

FIG. 4 is a block diagram illustrating one embodiment of a user equipment apparatus that may be used for predictive application context relocation;

FIG. 5 is a block diagram illustrating one embodiment of a network apparatus that may be used for predictive application context relocation;

FIG. 6 is a flowchart diagram illustrating one embodiment of a method for predictive application context relocation; and

FIG. 7 is a flowchart diagram illustrating one embodiment of another method for predictive application context relocation.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for predictive application context relocation. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

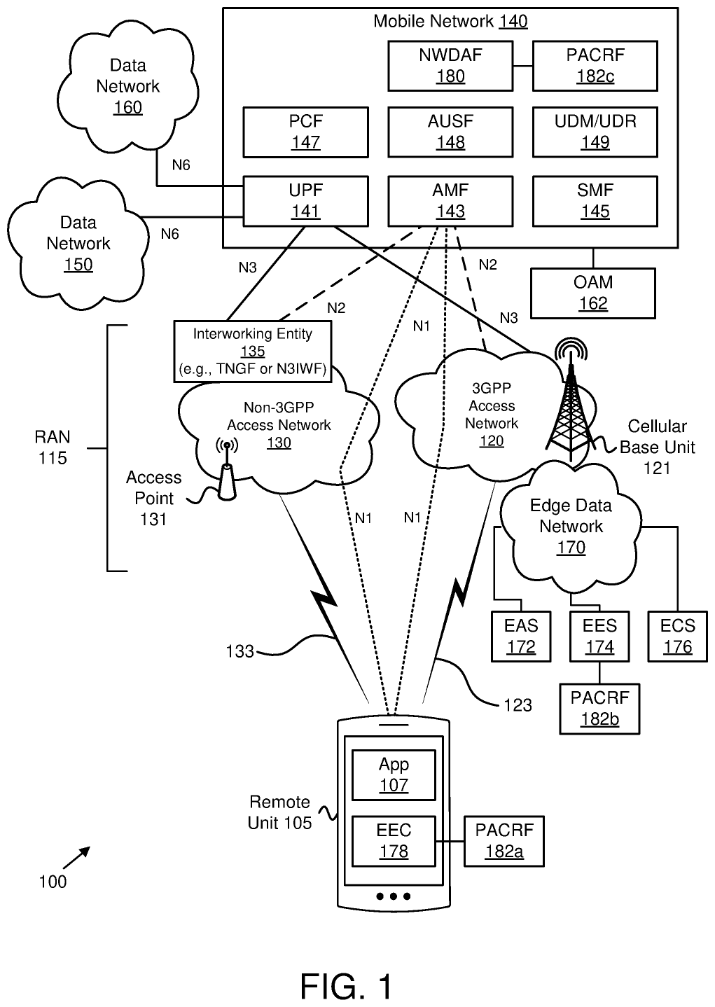

FIG. 1 depicts a wireless communication system 100 for predictive application context relocation, according to embodiments of the disclosure. In one embodiment, the wireless communication system 100 includes at least one remote unit 105, a Fifth-Generation Radio Access Network (“5G-RAN”) 115, and a mobile core network 140. The 5G-RAN 115 and the mobile core network 140 form a mobile communication network. The 5G-RAN 115 may be composed of a 3GPP access network 120 containing at least one cellular base unit 121 and/or a non-3GPP access network 130 containing at least one access point 131. The remote unit 105 communicates with the 3GPP access network 120 using 3GPP communication links 123 and/or communicates with the non-3GPP access network 130 using non-3GPP communication links 133. Even though a specific number of remote units 105, 3GPP access networks 120, cellular base units 121, 3GPP communication links 123, non-3GPP access networks 130, access points 131, non-3GPP communication links 133, and mobile core networks 140 are depicted in FIG. 1, one of skill in the art will recognize that any number of remote units 105, 3GPP access networks 120, cellular base units 121, 3GPP communication links 123, non-3GPP access networks 130, access points 131, non-3GPP communication links 133, and mobile core networks 140 may be included in the wireless communication system 100.

In one implementation, the RAN 120 is compliant with the 5G system specified in the Third Generation Partnership Project (“3GPP”) specifications. For example, the RAN 120 may be a NG-RAN, implementing NR RAT and/or LTE RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as UEs, subscriber units, mobiles, mobile stations, users, terminals, mobile terminals, fixed terminals, subscriber stations, user terminals, wireless transmit/receive unit (“WTRU”), a device, or by other terminology used in the art.

The remote units 105 may communicate directly with one or more of the cellular base units 121 in the 3GPP access network 120 via uplink (“UL”) and downlink (“DL”) communication signals. Furthermore, the UL and DL communication signals may be carried over the 3GPP communication links 123. Similarly, the remote units 105 may communicate with one or more access points 131 in the non-3GPP access network(s) 130 via UL and DL communication signals carried over the non-3GPP communication links 133. Here, the access networks 120 and 130 are intermediate networks that provide the remote units 105 with access to the mobile core network 140.

In some embodiments, the remote units 105 communicate with a remote host (e.g., in the data network 150 or in the data network 160) via a network connection with the mobile core network 140. For example, an application 107 (e.g., web browser, media client, telephone and/or Voice-over-Internet-Protocol (“VOIP”) application) in a remote unit 105 may trigger the remote unit 105 to establish a protocol data unit (“PDU”) session (or other data connection) with the mobile core network 140 via the 5G-RAN 115 (i.e., via the 3GPP access network 120 and/or non-3GPP network 130). The mobile core network 140 then relays traffic between the remote unit 105 and the remote host using the PDU session. The PDU session represents a logical connection between the remote unit 105 and a User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. Additionally—or alternatively—the remote unit 105 may have at least one PDU session for communicating with the packet data network 160. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 131. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QOS Identifier (“5Q1”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a Packet Gateway (“PGW”, not shown) in the mobile core network 130. In certain embodiments, there is a one-to-one mapping between an EPS Bearer and a QoS profile, such that all packets belonging to a specific EPS Bearer have the same QoS Class Identifier (“QCI”).

As described in greater detail below, the remote unit 105 may use a first data connection (e.g., PDU Session) established with the first mobile core network 130 to establish a second data connection (e.g., part of a second PDU session) with the second mobile core network 140. When establishing a data connection (e.g., PDU session) with the second mobile core network 140, the remote unit 105 uses the first data connection to register with the second mobile core network 140.

The cellular base units 121 may be distributed over a geographic region. In certain embodiments, a cellular base unit 121 may also be referred to as an access terminal, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a Home Node-B, a relay node, a device, or by any other terminology used in the art. The cellular base units 121 are generally part of a radio access network (“RAN”), such as the 3GPP access network 120, that may include one or more controllers communicably coupled to one or more corresponding cellular base units 121. These and other elements of radio access network are not illustrated but are well known generally by those having ordinary skill in the art. The cellular base units 121 connect to the mobile core network 140 via the 3GPP access network 120.

The cellular base units 121 may serve a number of remote units 105 within a serving area, for example, a cell or a cell sector, via a 3GPP wireless communication link 123. The cellular base units 121 may communicate directly with one or more of the remote units 105 via communication signals. Generally, the cellular base units 121 transmit DL communication signals to serve the remote units 105 in the time, frequency, and/or spatial domain. Furthermore, the DL communication signals may be carried over the 3GPP communication links 123. The 3GPP communication links 123 may be any suitable carrier in licensed or unlicensed radio spectrum. The 3GPP communication links 123 facilitate communication between one or more of the remote units 105 and/or one or more of the cellular base units 121. Note that during NR operation on unlicensed spectrum (referred to as “NR-U”), the base unit 121 and the remote unit 105 communicate over unlicensed (i.e., shared) radio spectrum.

The non-3GPP access networks 130 may be distributed over a geographic region. Each non-3GPP access network 130 may serve a number of remote units 105 with a serving area. An access point 131 in a non-3GPP access network 130 may communicate directly with one or more remote units 105 by receiving UL communication signals and transmitting DL communication signals to serve the remote units 105 in the time, frequency, and/or spatial domain. Both DL and UL communication signals are carried over the non-3GPP communication links 133. The 3GPP communication links 123 and non-3GPP communication links 133 may employ different frequencies and/or different communication protocols. In various embodiments, an access point 131 may communicate using unlicensed radio spectrum. The mobile core network 140 may provide services to a remote unit 105 via the non-3GPP access networks 130, as described in greater detail herein.

In some embodiments, a non-3GPP access network 130 connects to the mobile core network 140 via an interworking entity 135. The interworking entity 135 provides an interworking between the non-3GPP access network 130 and the mobile core network 140. The interworking entity 135 supports connectivity via the “N2” and “N3” interfaces. As depicted, both the 3GPP access network 120 and the interworking entity 135 communicate with the AMF 143 using a “N2” interface. The 3GPP access network 120 and interworking entity 135 also communicate with the UPF 141 using a “N3” interface. While depicted as outside the mobile core network 140, in other embodiments the interworking entity 135 may be a part of the core network. While depicted as outside the non-3GPP RAN 130, in other embodiments the interworking entity 135 may be a part of the non-3GPP RAN 130.

In one embodiment, the wireless communication system 100 includes an edge data network 170. The edge data network (“EDN”) 170 may be a network comprising servers, applications, functions, or the like that service users/UEs at the edge of the network that is closest to the end user, e.g., the cellular base unit 121. The EDN may include an edge application server (“EAS”) 172, an edge enabler server (“EES”) 174, and an edge configuration server (“ECS”) 176 (which may alternatively be located in the mobile network 140).

As used herein, the EAS 172 may comprise a server that executes application processing at an edge location, e.g., the EDN 170. In one embodiment, the EES 174, as used herein, may refer to a server that provides information related to edge applications, such as availability/enablement and related configuration, to the edge enabler client (“EEC”) 178 located on the remote unit 105/UE. The ECS 176, in certain embodiments, may refer to a server that provides configurations to the EEC 178 to connect with an EAS 172. The EEC 178, located at the remote unit 105/UE, may refer to a function/service executing on the remote unit 105/UE that provides support functions such as EAS discovery to application clients 107 on the remote unit 105/UE.

In certain embodiments, a non-3GPP access network 130 may be controlled by an operator of the mobile core network 140 and may have direct access to the mobile core network 140. Such a non-3GPP AN deployment is referred to as a “trusted non-3GPP access network.” A non-3GPP access network 130 is considered as “trusted” when it is operated by the 3GPP operator, or a trusted partner, and supports certain security features, such as strong air-interface encryption. In contrast, a non-3GPP AN deployment that is not controlled by an operator (or trusted partner) of the mobile core network 140, does not have direct access to the mobile core network 140, or does not support the certain security features is referred to as a “non-trusted” non-3GPP access network. An interworking entity 135 deployed in a trusted non-3GPP access network 130 may be referred to herein as a Trusted Network Gateway Function (“TNGF”). An interworking entity 135 deployed in a non-trusted non-3GPP access network 130 may be referred to herein as a non-3GPP interworking function (“N3IWF”). While depicted as a part of the non-3GPP access network 130, in some embodiments the N3IWF may be a part of the mobile core network 140 or may be located in the data network 150.

In one embodiment, the mobile core network 140 is a 5G core (“5GC”) or the evolved packet core (“EPC”), which may be coupled to a data network 150, like the Internet and private data networks, among other data networks. A remote unit 105 may have a subscription or other account with the mobile core network 140. Each mobile core network 140 belongs to a single public land mobile network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF (“UPF”) 141. The mobile core network 140 also includes multiple control plane functions including, but not limited to, an Access and Mobility Management Function (“AMF”) 143 that serves the 5G-RAN 115, a Session Management Function (“SMF”) 145, a Policy Control Function (“PCF”) 146, an Authentication Server Function (“AUSF”) 147, a Unified Data Management (“UDM”) and Unified Data Repository function (“UDR”).

The UPF(s) 141 is responsible for packet routing and forwarding, packet inspection, QoS handling, and external PDU session for interconnecting Data Network (“DN”), in the 5G architecture. The AMF 143 is responsible for termination of NAS signaling, NAS ciphering & integrity protection, registration management, connection management, mobility management, access authentication and authorization, security context management. The SMF 145 is responsible for session management (i.e., session establishment, modification, release), remote unit (i.e., UE) IP address allocation & management, DL data notification, and traffic steering configuration for UPF for proper traffic routing.

The PCF 146 is responsible for unified policy framework, providing policy rules to CP functions, access subscription information for policy decisions in UDR. The AUSF 147 acts as an authentication server.

The UDM is responsible for generation of Authentication and Key Agreement (“AKA”) credentials, user identification handling, access authorization, subscription management. The UDR is a repository of subscriber information and can be used to service a number of network functions. For example, the UDR may store subscription data, policy-related data, subscriber-related data that is permitted to be exposed to third party applications, and the like. In some embodiments, the UDM is co-located with the UDR, depicted as combined entity “UDM/UDR” 149.

In one embodiment, the mobile core network 140 includes a network data analytics function (“NWDAF”) 180 that collects data from UEs, network functions, OAM systems, and/or the like from the mobile network 140, 5G CN, cloud, and EDNs 170 that can be used for analytics related to the wireless communication system 100. Other DAFs may be used include big data and management and orchestration DAFs, application function level DAFs, UE/RAN DAFs, data network DAFs, and/or the like.

In various embodiments, the mobile core network 140 may also include an Network Exposure Function (“NEF”) (which is responsible for making network data and resources easily accessible to customers and network partners, e.g., via one or more APIs), a Network Repository Function (“NRF”) (which provides NF service registration and discovery, enabling NFs to identify appropriate services in one another and communicate with each other over Application Programming Interfaces (“APIs”)), or other NFs defined for the 5GC. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. A network instance may be identified by a S-NSSAI, while a set of network slices for which the remote unit 105 is authorized to use is identified by NSSAI. In certain embodiments, the various network slices may include separate instances of network functions, such as the SMF and UPF 141. In some embodiments, the different network slices may share some common network functions, such as the AMF 143. The different network slices are not shown in FIG. 1 for ease of illustration, but their support is assumed.

Although specific numbers and types of network functions are depicted in FIG. 1, one of skill in the art will recognize that any number and type of network functions may be included in the mobile core network 140. Moreover, where the mobile core network 140 comprises an EPC, the depicted network functions may be replaced with appropriate EPC entities, such as an MME, S-GW, P-GW, HSS, and the like.

While FIG. 1 depicts components of a 5G RAN and a 5G core network, the described embodiments for using a pseudonym for access authentication over non-3GPP access apply to other types of communication networks and RATs, including IEEE 802.11 variants, GSM, GPRS, UMTS, LTE variants, CDMA 2000, Bluetooth, ZigBee, Sigfoxx, and the like. For example, in an 4G/LTE variant involving an EPC, the AMF 143 may be mapped to an MME, the SMF mapped to a control plane portion of a PGW and/or to an MME, the UPF 141 may be mapped to an SGW and a user plane portion of the PGW, the UDM/UDR 149 may be mapped to an HSS, etc.

The subject matter disclosed herein describes solutions that utilize a predictive application context relocation (“ACR”) function (“PACRF”) 182, which may be located on a remote unit 105/UE (e.g., 182a as part of an EEC 178), in an EDN 170 (e.g., 182b as part of an EES 174), and/or as a function 182c in the mobile network 140 (collectively 182). As described in more detail below, the PACRF 182 is configured to provide context-aware predictive ACR to ensure edge service continuity based on network-related and application-related performance data/analytics monitoring.

The Operations, Administration and Maintenance (“OAM”) 162 is involved with the operating, administering, managing, and maintaining of the system 100. “Operations” encompass automatic monitoring of environment, detecting and determining faults and alerting admins. “Administration” involves collecting performance stats, accounting data for the purpose of billing, capacity planning using Usage data and maintaining system reliability. Administration can also involve maintaining the service databases which are used to determine periodic billing. “Maintenance” involves upgrades, fixes, new feature enablement, backup and restore and monitoring the media health. In certain embodiments, the OAM 162 may also be involved with provisioning, i.e., the setting up of the user accounts, devices, and services.

As depicted, a remote unit 105 (e.g., a UE) may connect to the mobile core network (e.g., to a 5G mobile communication network) via two types of accesses: (1) via 3GPP access network 120 and (2) via a non-3GPP access network 130. The first type of access (e.g., 3GPP access network 120) uses a 3GPP-defined type of wireless communication (e.g., NG-RAN) and the second type of access (e.g., non-3GPP access network 130) uses a non-3GPP-defined type of wireless communication (e.g., WLAN). The 5G-RAN 115 refers to any type of 5G access network that can provide access to the mobile core network 140, including the 3GPP access network 120 and the non-3GPP access network 130.

In mobile edge cloud deployments, one key aspect is the portability/migration of the edge applications to different EASs 172, while maintaining the edge service continuity. The reasons for application client (“AC”) to EAS remapping can be the following:
UE mobility, including predictive or expected UE mobility from an area covered by one EAS to a target area covered by another;
Overload situations in a source EAS 172 (“S-EAS”) or EDN 170;
Maintenance aspects such as graceful shutdown of an EAS 172;
Expected performance downgrade at the source EAS 170;
Improve quality of experience for the UE application 107 (e.g., a gaming application); and
Application preference on different slice/data network name (“DNN”)

If 5G is used for the communication between the edge application servers and clients, such migration to different EASs 172 will have an impact at the network side, for enabling the application context transfer (e.g., transfer of necessary application client context for the target EAS 172 (“T-EAS”), e.g., AC profile, service KPIs, or the like) with no disruption of the communication service, and without affecting the user QoE. At the same time, in one embodiment, it needs to be ensured that the target EAS 172 will be the best candidate based on the application requirements.

In one embodiment, an ACR service in Edge Enabler Layer (“EEL”) (e.g., as defined in 3GPP SA6 EDGEAPP (e.g., TS 23.558)), may be a middleware layer between the network and edge applications. Generally, the S-EAS 172 is associated with an application context. To support service continuity, this application context from the S-EAS 172 is transferred to a T-EAS 172.

Following intra-EDN, inter-EDN and LADN related scenarios are supported for service continuity:

To support the need of ACR, following entity roles are identified:
detection entity, detecting or predicting the need of ACR;
decision-making entity, deciding that the ACR is required; and
execution entity, executing ACR.

Different scenarios identified for ACR and in particular different scenarios correspond to:
whether the EEC 178 is involved in the detection phase and decision phase;
whether T-EAS 172 discovery is performed between ECC 178 and T-EES 174 or between S-EES 172 and T-EES 174;
whether the EEC 178 sends an Application Context Relocation Request towards the S-EES 172, the T-EES 174 or none at all; and
whether the Application Context is pushed from the S-EAS 172 to the T-EAS 172 or pulled by the T-EAS 172 from S-EAS 172.

One service related to ACR, from the EEL, is the service continuity planning/ACR. Service continuity planning, in one embodiment, is an Edge Enabler Layer value-add feature of providing support for seamless service continuity, when information about planned, projected, or anticipated behavior is available at EESs 174 or provided by EECs 178.

To implement this functionality an EES 174 may utilize:
information provided by the EEC e.g., AC Schedule, Expected AC Geographical Service Area, Expected Service KPIs, Preferred ECSP list; and
3GPP core network capabilities utilized by EES.

In service continuity planning, the Application Context may be duplicated and sent from the S-EAS 172 to the T-EAS 172 before the UE moves to the expected location. In this case, the Application Contexts in S-EAS 172 and T-EAS 172 may be synchronized when the Application Context is updated until the AC connects to the T-EAS 172.

In one embodiment, the information elements of the Application Context and how the Application Context is synchronized between the S-EAS 172 and the T-EAS 172 is up to implementation of the application. In the case of automated ACR, in one embodiment, the Application Context synchronization is accomplished using the same mechanism as when transferring the context from the S-EES 174 to the T-EES 174.

The planned ACR, in one embodiment, currently considers the UE mobility to an area covered by the T-EAS 172; however, the following aspects are not captured and could enhance the value-add service of the EEL:

Issue 1: How the UE location/mobility is predicted/expected is not studied. It is assumed that EEC 178 will be aware of the expected mobility/location. There could be different ways of calculating/predicting the UE location/mobility and different granularities of prediction (EEC 178 needs to translate the expected route/coordinates to the mapping to the most appropriate T-EAS 172). Such aspects will have some impact on the EEC 178 capabilities and the EDGE-x interfaces.

Issue 2: The expected ACR to a T-EAS 172 may not be only triggered by an expected UE location/mobility, but also (or alternatively) can be triggered based on the performance metrics and/or analytics of the candidate T-EAS(s) 172. This will allow the pro-active/dynamic selection of the best T-EAS 172 for the target UE. However, how such condition can affect the ACR detection is not discussed.

Issue 3: The performance metrics/analytics may be based on the expected e2e QoS metrics at the candidate T-EASs 172; however, such performance metrics/analytics may need to consider the RAN/cell-level performance conditions to ensure that the best decision is made (e.g., for the scenarios where more than one T-EAS 172 cover overlapping edge service areas).

To deal with these issues, the problem to be solved in this disclosure is how to ensure edge service continuity by supporting pro-active ACR based on network-related and application-related performance data/analytics monitoring.

At a high level, the proposed solutions described herein provide a mechanism for triggering a predictive ACR based on a predicted UE route and performance data analytics from NWDAF 180 and/or performance data/data analytics from ETSI mobile edge computing (“MEC”)/radio network information service (“RNIS”). In one embodiment, the mechanism has the following steps:
the configuration of policies for the migration of the UE at the ACR decision/detection entity or at the ECS 176 (when configuring the policies for EDN 170 selection);
the proactive ACR trigger at the ACR decision/detection entity and considers a combination of UE route data, network analytics, RAN measurements, and the like to identify 1) whether to perform an ACR or a series of ACRs, and 2) when and to which EASs 172 to migrate;
the monitoring at the ACR decision/detection entity of the conditions from the proactive ACR trigger until the application context transfer (“ACT”) to the last EAS 172 and based on the monitoring the adaptation of the ACR trigger accordingly (e.g., if a prediction error occurs).

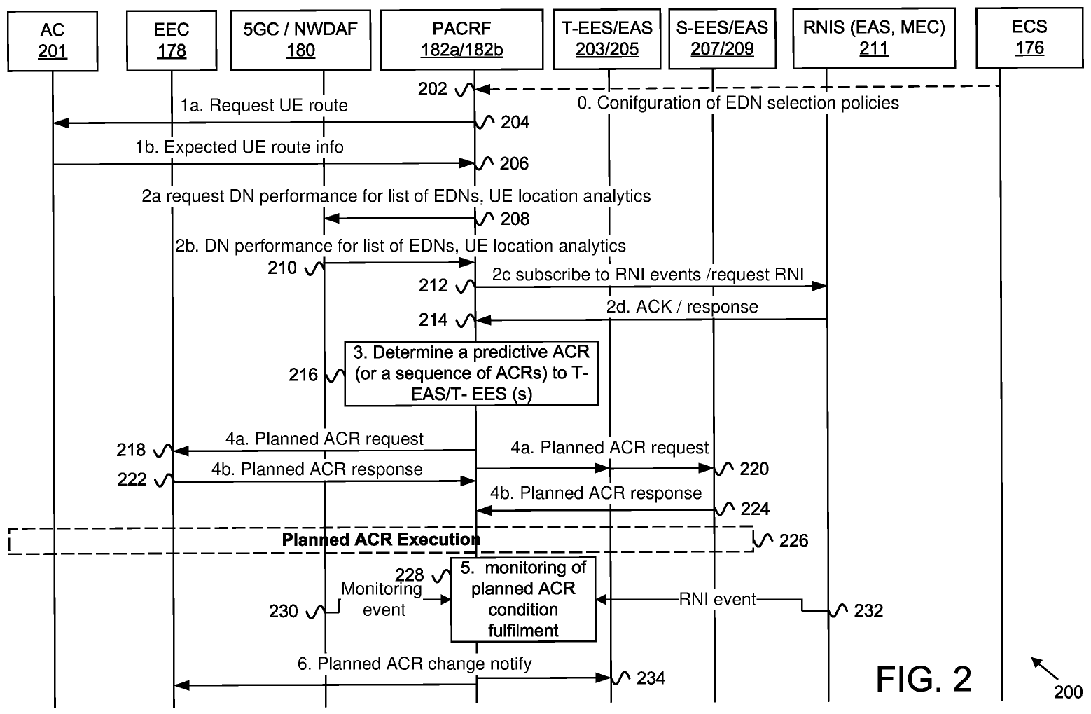

FIG. 2 depicts one embodiment of a procedure flow for predictive ACR from the application side/middleware. In one embodiment, the procedure 200 includes an AC 201, an EEC 178, a 5GC/NWDAF 180, a PACRF 182a/182b (collectively 182), a T-EES 203/T-EAS 205, an S-EES 207/S-EAS 209, an RNIS 211, and an ECS 176.

In one embodiment, at step 0, the ECS 176 (or OAM 162) provides (see messaging 202) policies related to how the AC shall select the best EAS 205/EDN 170. Such configuration policies may include:
selecting the T-EAS 205/T-EES 203 that will be closer to the UE (topologically or geographically);
selecting the T-EAS 205/T-EES 203 that fulfils the QoS requirements (based on the performance analytics) and is the least congested/loaded;
selecting the T-EAS 205/T-EES 203 that fulfils the QoS requirements (based on the performance analytics), and the involved RAN node is the least congested/loaded;
selecting the T-EAS 205/T-EES 203 that fulfils the QoS requirements and has the largest coverage (to avoid further relocations);
selecting the T-EAS 205/T-EES 203 that fulfils the QoS requirements and provides the highest performance (e.g., this can be for some applications that may benefit from the higher performance e.g., gaming applications, streaming applications, or the like that may need to increase video resolution rates).

At step 1a and 1b, in one embodiment, a predictive ACR Function (“PACRF”) 182, which may be deployed either at the EEC 178 or at the source/target EES 203/207, requests (see messaging 204) and receives (see messaging 206) the expected/predicted/forecasted UE route from the AC 201 (e.g., a GPS route) when the AC session is initiated, when the AC 201 is connected/registered to 5GS, and/or the like.

In one embodiment, if the functionality resides at the EES 203/207, then the expected UE route may be transferred from the AC 201 to the EEC 178 (e.g., over EDGE-5) and then from the EEC 178 to the EES 203/207 (e.g., over EDGE-4). The reception of the expected route info may also be received from the application server or from other sources (e.g., 3GPP or non-3GPP networks). In certain embodiments, this information can be derived by the AC profile, e.g., from “Expected AC Geographical Service Area” IE as in TS 23.558 8.2.2.

In one embodiment, the expected UE route message may include the following parameters: a start location, an end location, zero or more intermediate locations between the start and the end location, a list of cells/service areas between the start and end locations, a latitude, a longitude, an altitude of one or more waypoints within the start and end locations, and/or the like.

At step 2a, in one embodiment, the PACRF 182, based on the expected route reception, may request (or may subscribe to receive) (see messaging 208) information from the NWDAF 180 via an NEF acting as an AF (or if the PACRF 182 is deployed at EEC 178, indirectly requests NWDAF analytics via the AF via the NEF). This information may help PACRF 182 to identify the expected performance of the UE/network within the expected UE route. Such analytics may include the following:
Observed service experience information for the target application;
Network performance information;
UE mobility information for the UE running the target application;
Expected UE behavioral parameters for the UE running the target application;
Data network (“DN”) performance for the list of EASs 205/209 or EDNs 170 covering the area where the UE moves or is expected to move, which may be for the entire route of the UE.

The request for the DN performance analytics may require new performance data parameters, e.g., in 3GPP TS 23.288, as shown below:

TABLE 1
Performance Data from AF

| Information | Source | Description |
|---|---|---|
| UE identifier | AF | IP address of the UE at the time the |
| | | measurements was made. |
| UE location | AF | The location of the UE when the performance |
| | | measurement was made. |
| UE future location/route/ | AF | The expected/predicted UE location or route, |
| trajectory | | which may be in form of a list of waypoints, or |
| | | a list cell IDs/civic addresses |
| Time horizon | AF | The list of time instances in which the UE is |
| | | expected to be in these waypoints |
| List of DNAIs. | AF | The list of a user plane access to the DNS |
| | | where applications are expected to be deployed |
| | | over the expected/predicted UE location/route |
| Application policy on DN | AF | In case when NWDAF prescribes the best DN, |
| selection | | these policies can relate to how the network |
| | | shall select the best DN to connect to. |
| Application ID | AF | To identify the service and support analytics |
| | | per type of service (the desired level of |
| | | service). |
| IP filter information | AF | Identify a service flow of the UE for the |
| | | application. |
| Locations of Application | AF/NEF | Locations of application represented by a list |
| | | of DNAI(s). The NEF may map the AF- |
| | | Service-Identifier information to a list of |
| | | DNAI(s) when the DNAI(s) being used by the |
| | | application are statically defined. |
| Application Server Instance | AF/NEF | The IP address/FQDN of the Application |
| address | | Server that the UE had a communication |
| | | session when the measurement was made. |
| Performance Data | AF | The performance associated with the |
| | | communication session of the UE with an |
| | | Application Server that includes: Average |
| | | Packet Delay, Average Loss Rate and |
| | | Throughput. |
| Timestamp | AF | A time stamp associated to the Performance |
| | | Data provided by the AF. |

At step 2b, the PACRF 182 receives (see messaging 210) the requested analytics. In particular, acting as AF, it receives the DN performance statistics and/or predictions, including new parameters in the performance data, e.g., in 3GPP TS 23.288, as shown below

TABLE 2
DN Service Performance Statistics

| Information | Description |
|---|---|
| Application ID | Identifies the application for which analytics information is |
| | provided. |
| S-NSSAI | Identifies the Network Slice for which analytics information |
| | is provided. See note 1. |
| DNN/List of DNNs within the | Identifies the data network name (e.g., “internet”) for which |
| route | analytics information is provided. See NOTE 1. |
| DN performance (0-x) | List of DN performances for the application. |
| > Application Server Instance | Identifies the Application Server Instance (IP address/FQDN |
| Address | of the Application Server). |
| > Serving anchor UPF | The involved anchor UPF. See NOTE 2. |
| > DNAI | Identifier of a user plane access to one or more DN(s) where |
| | applications are deployed as defined in TS 23.501 [2]. |
| > Performance | Performance indicators. |
| >> Average Traffic rate | Average traffic rate observed for UEs communicating with |
| | the application. See NOTE 3. |
| >> Maximum Traffic rate | Maximum traffic rate observed for UEs communicating with |
| | the application. See NOTE 3. |
| >>Average Packet Delay | Average packet delay observed for UEs communicating with |
| | the application. See NOTE 3. |
| >>Maximum Packet Delay | Maximum packet delay for observed for UEs |
| | communicating with the application. See NOTE 3. |
| >> Average Packet Loss Rate | Average packet loss observed for UEs communicating with |
| | the application. See NOTE 3. |
| > Spatial Validity Condition | Area where the DN performance analytics applies. |
| > Temporal Validity Condition | Validity period for the DN performance analytics. |
| > Recommendation of best | Only if prescription is on, recommend the best DNs along |
| DN(s) for the application | the expected/predicted route |
| > per expected/predicted route | Providing the list of performances per DN for each waypoint |
| performance | (in case of prescription) Averaging performance for all |
| | waypoints within the path if the recommended DNs are used |
| | (there can be also performance estimates for backup DNs |
| | selection) |

NOTE 1:
The item “DNN” and “S-NSSAI” shall not be included if the consumer NF is an untrusted AF.
NOTE 2:
The item “Serving anchor UPF” shall not be included if the consumer is an AF.
NOTE 3:
Analytics subset that can be used in “list of analytics subsets that are requested”, “Accuracy level per analytics subset” and “Reporting Thresholds”.

At step 2c, in one embodiment, the PACRF 182 may request (or subscribes to receive) (see messaging 212) additional information from RNIS 211 from a MEC platform (e.g., using RNI API) about the per cell radio conditions for one or more cells within the UE route, or events related to a RAN condition change/UE cell change. This message may include the request/subscription for the following parameters: RAN/L2 measurements from target cell or list of cells, radio bearer information/status from cell(s), a subscription for receiving actual or predicted cell change notifications for a target UE, predictive radio bearer utilization/status, and/or the like.

At step 2d, in one embodiment, the PACRF 182 receives (see messaging 214) the requested radio measurements for one or more radio access networks. In particular the PACRF 182 may receive one or more of the following parameters:
L2 measurements (L2meas);
RABinfo;
NrMeasRepUeNotification;
CellChangeNotification;
Predicted Cell Change Notification; and
Predicted radio bearer utilization.

At step 3, in one embodiment, the PACRF 182, based on the received inputs in step 1b and 2d, as well as other information, e.g., end-to-end QoS/QoE requirements, evaluates (see block 216) whether one or more ACRs need to be performed proactively for the UE and optionally provides a recommendation or decision of the expected T-EASs 205 including after which time instance it is expected to perform the context transfer. The information on the cell-level parameters may be used to support the decision, to capture real-time conditions on the RAN resources, as well as events for expected cell handovers for one or more UEs within the application. Also, the PACRF 182 may send an expiration time for the expected relocation (e.g., in cases when the prediction is not correct, e.g., if the UE does not move to the target area).

In one embodiment, if there is a prescription/recommendation from NWDAF 180 about the recommended DNs within an expected/predicted UE route, then PACRF 182 translates each of the DNs to the optimal EAS 209 based on the determined policy.

At step 4a, the PACRF 182, after selecting the best T-EAS 205/T-EES 203 (or a sequence/series of T-EASs 205/T-EESs 203 along the expected UE route), sends (see messaging 218, 220) the trigger command to the entity/entities performing the ACR execution, so as to proactively start an ACR at given time instances. Such command may be in form of a planned ACR request message and may include one or more of the following parameters:

TABLE 3
Planned ACR Request Parameters

| Information element | Status | Description |
|---|---|---|
| Requestor Identifier | M | Unique identifier of the requestor |
| | | (i.e., EECID or EASID). |
| Security credentials | M | Security credentials resulting from a |
| | | successful authorization for the edge |
| | | computing service. |
| UE identifier | O | The identifier of the UE (i.e., GPSI). |
| Planned ACR | M | Indicates the ACR action (ACR |
| initiation data | | initiation or ACR determination) |
| > List of T-EAS | M | Endpoints information (e.g., URI, |
| Endpoints | | FQDN, IP 3-tuple) of the T-EAS(s). |
| > List of DNAIs per | O | DNAI information associated with each |
| T-EAS | | T-EAS. |
| > N6 Traffic Routing | O | The N6 traffic routing information |
| requirements | | and/or routing profile ID corresponding |
| | | to the T-EAS(s) DNAI(s). |
| > EAS notification | M | Indicates whether to notify the EAS |
| indication | | about the planned ACR. |
| > S-EAS endpoint | O | Endpoint information of the S-EAS |
| Predictive timer/time | O | The min-max time where an ACR is |
| range per ACR | | expected. This depends on the planning |
| | | on when the UE is expected to move to |
| | | that area, and the range depends on the |
| | | confidence level. The execution entity |
| | | will identify when to start the ACR |
| | | based on the planned ACR request |

At step 4b, the PACRF 182 receives (see messaging 222, 224) a response from the decision/execution entities (e.g., an EES 203/207, an EAS 205/209, an EEC 178) to the planned ACR request. This planned ACR response message may include the following parameters:

TABLE 4
Planned ACR Response Parameters

| | | |
|---|---|---|
| Result | M | Indicates whether the request is successful |
| | | or failure |
| Cause | O | Indicates the cause information for the |
| information | | failure of the planned ACR recommendation |

After Step 4b, in one embodiment, the proactive ACR execution occurs (see block 226), when the decision/execution is planned based on the predictive timer. The cleanup phase, in certain embodiments, happens when the UE actually relocates to the next EAS 209 (e.g., context is erased at the source EAS 307).

At step 5, in one embodiment, the PACRF 182 monitors (see block 228) whether the conditions for the planned ACR are fulfilled. In one embodiment, this is based on the location reporting from 5GC 180 or from the EEC/AC 178/201, or via subscribing to receive monitoring event notifications from 5GC (see messaging 230), or via subscribing to receive (see messaging 232) RNIS information on expected congestion at the target cell area where the UE is expected to move.

In one embodiment, 5GC events can include NEF monitoring events on the network status, the UE location/mobility change, QoS downgrade indication, and/or the like. RNI events, in certain embodiments, include an actual/predicted cell change notification, a RAB related modification/threshold (e.g., high utilization), and/or the like.

At step 6, in one embodiment, the PACRF 182, if the conditions for the planning need to change (e.g., the UE is not moving to a target area, or the target DN becomes congested), sends (see messaging 234) a planned ACR change notification message to the decision/execution entities. This message may include the following parameters:

TABLE 5
Planned ACR Change Parameters

| Information element | Status | Description |
|---|---|---|
| Subscription ID | M | Subscription identifier corresponding to |
| or UE ID | | the subscription stored in the EES for |
| | | the request, or UE ID (GPSI) |
| Planned T-EASID | M | The identifier of the planned T-EAS |
| Event ID | M | The event corresponding to the ACR |
| | | planning change |
| Target information | O | Details of the newly selected T-EAS |
| | | and the T-EES, based on the planned |
| | | ACR change |
| > T-EAS information | M | Details of the new planned T-EAS |
| > T-EES information | O | Details of the new planned T-EES |
| > DNAI of newly | O | DNAI information associated with |
| selected T-EAS | | new T-EAS. |
| Cause information | O | Indicates the cause information for |
| | | the change (e.g., mobility change, |
| | | DN congestion) |

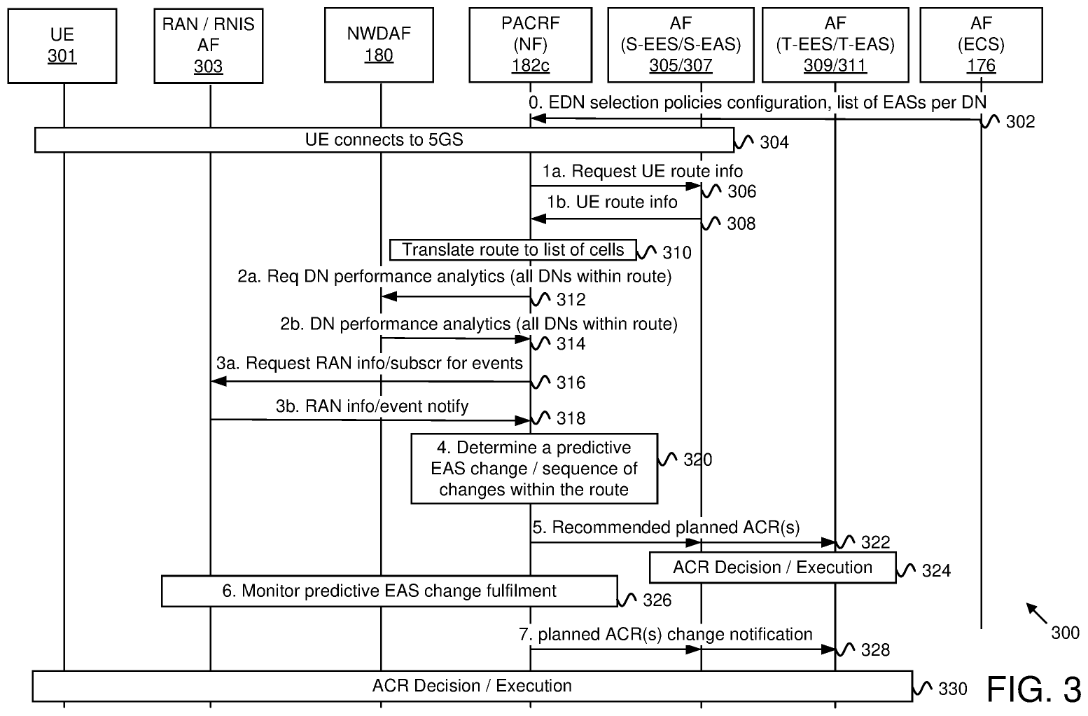

FIG. 3 depicts one embodiment of a procedure flow for predictive ACR from the network side, e.g., as a network function in the mobile network 140. In one embodiment, the procedure 300 includes a UE 301, a RAN/RNIS AF 303, an NWDAF 180, a PACRF NF 182c, a S-EES 305/S-EAS 307, a T-EES 309/T-EAS 311, and an ECS 176.

In the depicted procedure 300, as a general overview, an AF requests from the PACRF 182c, which can be NWDAF 180, PCF or a new NF, what is the best target EAS 311 or list of EASs 311 based on the expected UE trajectory, or based on a start and end point, and the application policies for selecting target EASs 311/DNs. In one embodiment, such policies can be for example, selecting the EAS 311 that is closer to the UE, or selecting the EAS 311 that is least loaded, and/or the like). The request may be sent to PACRF 182c as follows:
Request DN performance analytics, including a list of DNs and a UE trajectory where the UE trajectory is provided by a starting location, an intermediate location, and a finishing location; and
Request, via a new service operation, a recommendation for a best EAS 311 to achieve a specific target. The target may be specific DN performance target, a specific user experience target, and/or the like. A performance target may be an application end-to-end (e.g., UE to target DN) QoS/QoE target for a service operation and may be in a form of a minimum bit rate, a minimum packet latency, a minimum allowable reliability/PER, an energy efficiency, a maximum jitter, and/or the like.

PACRF 182c may translate the UE trajectory to a list of cells, where the UE is expected to pass through. PACRF 182c may ask from NWDAF 180 DN performance analytics based on the UE trajectory/translated path (e.g., for all or subset of DNs within the UE path). In one embodiment, if the PACRF 182c is an NWDAF 180, then the PACRF 182c may find a different NWDAF 180 to send a request or this may be an internal operation within the PACRF 182c. In one embodiment, the PACRF 182c may ask the NWDAF 180 for a recommendation of the best EAS 311 to achieve a performance target via a specific route.

In one embodiment, the PACRF 182c receives the DN performance analytics from the NWDAF 180 for the expected UE trajectory/translated path. In one embodiment, the PACRF 182c computes/selects the best EAS 311/list of EASs 311 that achieve the performance target and will send it to the target EES 309/EAS 311. The PACRF 182c may also monitor (e.g., based on an AF request), the UE location to trigger an adaptation on the best target EAS 311.

At step 0, the ECS 176, acting as an AF, provides (see messaging 302) policies related to how the UE/application shall select the best EAS 311/EDN. Such configuration policies may be similar to step 1 of procedure 2, discussed above with reference to FIG. 2. This can be provided directly to the PACRF 182c, via NEF or via CAPIF APIs.

In one embodiment, the UE connects to the 5GS (see block 304). At steps 1a and 1b, the PACRF NF 182c requests (see messaging 306) and receives (see messaging 308) the expected UE route from the source EAS 305 or EES 307 or from the AC (e.g., indirectly via EAS 307). The reception of the expected route info may also be received from other sources (e.g., 3GPP, non-3GPP networks, a global application server, and/or the like)

The expected UE route message may include the following parameters: a start location, an end location, zero or more intermediate locations between the start and the end locations, a list of cells/service areas between the start and end locations, a latitude, a longitude, an altitude of one or more waypoints within the start and end locations, and/or the like

PACRF NF 182c may translate (see block 310) the UE trajectory to a list of cells that the UE is expected to pass through. At step 2a, in one embodiment, the PACRF NF 182c, based on the expected route reception, requests (see messaging 312), or subscribes to receive, information from the NWDAF 180 via NEF acting as AF (or if deployed at EEC 178, indirectly requests NWDAF analytics via AF via NEF).

In one embodiment, this information helps the PACRF 182c to identify the expected performance of the UE/network within the route and select an EAS server 311 that achieves the performance target. Such analytics may include the following: observed service experience information for the target application, network performance information, expected UE behavioral parameters for the UE running the target application, DN performance for the list of EDNs covering the area where the UE moves or is expected to move, which may be for the whole route of the UE, and/or the like.

The NWDAF 180, in one embodiment, calculates the DN performance analytics (e.g., statistics or predictions) as follows:
If a UE route is provided, the NWDAF 180 determines the DN performance for each EAS 311 server the UE had a communication at each service area;
If aggregation was requested (e.g., performance of a server) at a UE route, the NWDAF 180 identifies whether UE(s) had a communication with the same EAS server(s) 311 at each location in the UE route and determines an aggregate DN performance of the EAS server 311 at a UE route.

At step 2b, the PACRF 182c receives (see messaging 314) the requested analytics. In particular, the PACRF 182c acting as NF receives the DN performance statistics, including the parameters listed in Table 2, with the addition of one or more of the following parameters:
Performance for each EAS server 311 that a UE has a communication with within the route;
Recommendation of best EAS server 311 within the route, if requested by the PACRF 182c; and
Aggregated performance per EAS server 311 on the UE route/DN selection.

At step 3a, in one embodiment, the PACRF 182c requests (see messaging 316), or subscribes to receive, additional information from RNIS 303 from a MEC platform (e.g., RNIS 303 acting as AF) or from RAN functions (e.g., RCAF) about the per cell radio conditions, for one or more cells within the UE route, events related to a RAN condition change/UE cell change, and/or the like. This message may comprise the request/subscription for the following parameters: RAN/L2 measurements from target cell or list of cells, radio bearer info/status from cell/cells, subscription for receiving actual or predicted cell change notification for a target UE, predictive radio bearer utilization/status, and/or the like.

At step 3b, in one embodiment, the PACRF 182c receives (see messaging 318) the requested radio measurements. In particular, the PACRF 182c receives L2meas, RABinfo, NrMeasRepUeNotification, CellChangeNotification, predicted cell change notification, predicted radio bearer utilization, and/or the like.

At step 4, in one embodiment, the PACRF 182c, based on the received inputs in prior steps as well as other information such as the end-to-end QoS/QoE requirements, evaluates (see block 320) whether one or more ACRs need to be performed pro-actively for the UE and optionally provides a recommendation or decision of the expected T-EASs 311 and after which time instance the T-EASs 311 are expected to perform the context transfer. The information on the cell-level parameters may be used to support the decision, to capture real-time conditions on the RAN resources, as well as events for expected cell handovers for one or more UEs within the application. Also, the PACRF 182c, in one embodiment, may send an expiration time for the expected relocation (e.g., in cases when the prediction is not correct, e.g., if the UE does not move to the target area).

At step 5, in one embodiment, the PACRF 182c, after selecting the best T-EAS 311/T-EES 309, or a sequence of T-EASs 311/T-EESs 309 along the UE route, sends (see messaging 322) the trigger command to the entities performing the ACR decision/execution, so as to proactively start an ACR at given time instances. This may be either the target EES 309/EAS 311 or source EES 305/EAS 307. In one embodiment, such command may be a guidance/recommendation to the application that will actually decide the ACR planning.

After Step 5, in one embodiment, the proactive ACR execution occurs (see block 324), when the decision/execution is planned based on the predictive timer. The cleanup phase, in one embodiment, occurs when the UE actually relocates to the next EAS 311 (e.g., context is erased at the source EAS 307).

At step 6, in one embodiment, the PACRF 182c monitors (see block 326) whether the conditions for the planned ACR are fulfilled. This can be based on the location reporting from NWDAF 180 or based on the subscription to receive monitoring event notifications to receive RNIS/RAN 303 information for expected congestion at the target cell area where the UE is expected to move.

At Step 7, in one embodiment, the PACRF 182c, if the conditions for the planning need to change (e.g., if the UE is not moving to a target area, or the target DN becomes congested), sends (see messaging 328) a planned ACR change notification message to the decision/execution entity, and the changed ACR decision/execution is performed (see block 330).

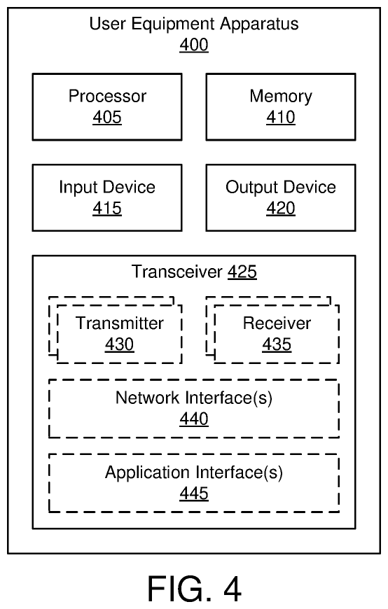

FIG. 4 depicts a user equipment apparatus 400 that may be used for predictive application context relocation, according to embodiments of the disclosure. In various embodiments, the user equipment apparatus 400 is used to implement one or more of the solutions described above. The user equipment apparatus 400 may be one embodiment of the remote unit 105 and/or the UE 205, described above. Furthermore, the user equipment apparatus 400 may include a processor 405, a memory 410, an input device 415, an output device 420, and a transceiver 425.

In some embodiments, the input device 415 and the output device 420 are combined into a single device, such as a touchscreen. In certain embodiments, the user equipment apparatus 400 may not include any input device 415 and/or output device 420. In various embodiments, the user equipment apparatus 400 may include one or more of: the processor 405, the memory 410, and the transceiver 425, and may not include the input device 415 and/or the output device 420.

As depicted, the transceiver 425 includes at least one transmitter 430 and at least one receiver 435. In some embodiments, the transceiver 425 communicates with one or more cells (or wireless coverage areas) supported by one or more base units 121. In various embodiments, the transceiver 425 is operable on unlicensed spectrum. Moreover, the transceiver 425 may include multiple UE panel supporting one or more beams. Additionally, the transceiver 425 may support at least one network interface 440 and/or application interface 445. The application interface(s) 445 may support one or more APIs. The network interface(s) 440 may support 3GPP reference points, such as Uu, N1, PC5, etc. Other network interfaces 440 may be supported, as understood by one of ordinary skill in the art.

The processor 405, in one embodiment, may include any known controller capable of executing computer-readable instructions and/or capable of performing logical operations. For example, the processor 405 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 405 executes instructions stored in the memory 410 to perform the methods and routines described herein. The processor 405 is communicatively coupled to the memory 410, the input device 415, the output device 420, and the transceiver 425. In certain embodiments, the processor 405 may include an application processor (also known as “main processor”) which manages application-domain and operating system (“OS”) functions and a baseband processor (also known as “baseband radio processor”) which manages radio functions.

The memory 410, in one embodiment, is a computer readable storage medium. In some embodiments, the memory 410 includes volatile computer storage media. For example, the memory 410 may include a RAM, including dynamic RAM (“DRAM”), synchronous dynamic RAM (“SDRAM”), and/or static RAM (“SRAM”). In some embodiments, the memory 410 includes non-volatile computer storage media. For example, the memory 410 may include a hard disk drive, a flash memory, or any other suitable non-volatile computer storage device. In some embodiments, the memory 410 includes both volatile and non-volatile computer storage media.

In some embodiments, the memory 410 stores data related to predictive application context relocation. For example, the memory 410 may store various parameters, panel/beam configurations, resource assignments, policies, and the like as described above. In certain embodiments, the memory 410 also stores program code and related data, such as an operating system or other controller algorithms operating on the user equipment apparatus 400.

The input device 415, in one embodiment, may include any known computer input device including a touch panel, a button, a keyboard, a stylus, a microphone, or the like. In some embodiments, the input device 415 may be integrated with the output device 420, for example, as a touchscreen or similar touch-sensitive display. In some embodiments, the input device 415 includes a touchscreen such that text may be input using a virtual keyboard displayed on the touchscreen and/or by handwriting on the touchscreen. In some embodiments, the input device 415 includes two or more different devices, such as a keyboard and a touch panel.

The output device 420, in one embodiment, is designed to output visual, audible, and/or haptic signals. In some embodiments, the output device 420 includes an electronically controllable display or display device capable of outputting visual data to a user. For example, the output device 420 may include, but is not limited to, an LCD display, an LED display, an OLED display, a projector, or similar display device capable of outputting images, text, or the like to a user. As another, non-limiting, example, the output device 420 may include a wearable display separate from, but communicatively coupled to, the rest of the user equipment apparatus 400, such as a smart watch, smart glasses, a heads-up display, or the like. Further, the output device 420 may be a component of a smart phone, a personal digital assistant, a television, a table computer, a notebook (laptop) computer, a personal computer, a vehicle dashboard, or the like.

In certain embodiments, the output device 420 includes one or more speakers for producing sound. For example, the output device 420 may produce an audible alert or notification (e.g., a beep or chime). In some embodiments, the output device 420 includes one or more haptic devices for producing vibrations, motion, or other haptic feedback. In some embodiments, all, or portions of the output device 420 may be integrated with the input device 415. For example, the input device 415 and output device 420 may form a touchscreen or similar touch-sensitive display. In other embodiments, the output device 420 may be located near the input device 415.

The transceiver 425 communicates with one or more network functions of a mobile communication network via one or more access networks. The transceiver 425 operates under the control of the processor 405 to transmit messages, data, and other signals and also to receive messages, data, and other signals. For example, the processor 405 may selectively activate the transceiver 425 (or portions thereof) at particular times in order to send and receive messages.

The transceiver 425 includes at least transmitter 430 and at least one receiver 435. One or more transmitters 430 may be used to provide UL communication signals to a base unit 121, such as the UL transmissions described herein. Similarly, one or more receivers 435 may be used to receive DL communication signals from the base unit 121, as described herein. Although only one transmitter 430 and one receiver 435 are illustrated, the user equipment apparatus 400 may have any suitable number of transmitters 430 and receivers 435. Further, the transmitter(s) 430 and the receiver(s) 435 may be any suitable type of transmitters and receivers. In one embodiment, the transceiver 425 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 425, transmitters 430, and receivers 435 may be implemented as physically separate components that access a shared hardware resource and/or software resource, such as for example, the network interface 440.

In various embodiments, one or more transmitters 430 and/or one or more receivers 435 may be implemented and/or integrated into a single hardware component, such as a multi-transceiver chip, a system-on-a-chip, an ASIC, or other type of hardware component. In certain embodiments, one or more transmitters 430 and/or one or more receivers 435 may be implemented and/or integrated into a multi-chip module. In some embodiments, other components such as the network interface 440 or other hardware components/circuits may be integrated with any number of transmitters 430 and/or receivers 435 into a single chip. In such embodiment, the transmitters 430 and receivers 435 may be logically configured as a transceiver 425 that uses one more common control signals or as modular transmitters 430 and receivers 435 implemented in the same hardware chip or in a multi-chip module.

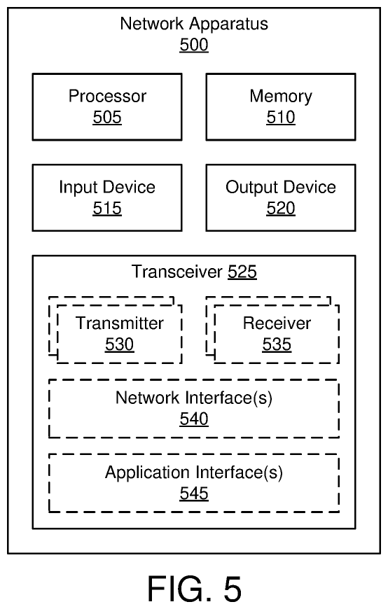

FIG. 5 depicts a network apparatus 500 that may be used for predictive application context relocation, according to embodiments of the disclosure. In one embodiment, network apparatus 500 may be one implementation of a RAN node, such as the base unit 121, the RAN node 210, or gNB, described above. Furthermore, the base network apparatus 500 may include a processor 505, a memory 510, an input device 515, an output device 520, and a transceiver 525.

In some embodiments, the input device 515 and the output device 520 are combined into a single device, such as a touchscreen. In certain embodiments, the network apparatus 500 may not include any input device 515 and/or output device 520. In various embodiments, the network apparatus 500 may include one or more of: the processor 505, the memory 510, and the transceiver 525, and may not include the input device 515 and/or the output device 520.

As depicted, the transceiver 525 includes at least one transmitter 530 and at least one receiver 535. Here, the transceiver 525 communicates with one or more remote units 105. Additionally, the transceiver 525 may support at least one network interface 540 and/or application interface 545. The application interface(s) 545 may support one or more APIs. The network interface(s) 540 may support 3GPP reference points, such as Uu, N1, N2 and N3. Other network interfaces 540 may be supported, as understood by one of ordinary skill in the art.

The processor 505, in one embodiment, may include any known controller capable of executing computer-readable instructions and/or capable of performing logical operations. For example, the processor 505 may be a microcontroller, a microprocessor, a CPU, a GPU, an auxiliary processing unit, a FPGA, or similar programmable controller. In some embodiments, the processor 505 executes instructions stored in the memory 510 to perform the methods and routines described herein. The processor 505 is communicatively coupled to the memory 510, the input device 515, the output device 520, and the transceiver 525. In certain embodiments, the processor 805 may include an application processor (also known as “main processor”) which manages application-domain and operating system (“OS”) functions and a baseband processor (also known as “baseband radio processor”) which manages radio function.

In various embodiments, the network apparatus 500 is a control device that executes a PACRF embodied as a middleware function. In one embodiment, a transceiver 525 receives, at a mobile edge computing function of a mobile wireless communication network from an application, a predicted route for a user equipment (“UE”) device and receives, at the mobile edge computing function from at least one data analytics service producer, data analytics parameters for at least one of a radio access network, a core network, and an edge data network associated with the predicted route of the UE.

In one embodiment, the processor 505 determines at least one predictive trigger action for remapping an application client (“AC”) from a first edge application server of a first edge data network to a second edge application server of a second edge data network based on the predicted route for the UE and the data analytics parameters and determines a planned predictive application context relocation for the AC from the first edge application server of the first edge data network to the second edge application server of the second edge data network based on the trigger action.

In one embodiment, the processor 505 further configures a policy for performing the planned predictive application context relocation for the AC, the policy comprising at least one rule for selecting an edge application server and/or an edge data network for remapping the AC.

In one embodiment, the transceiver 525 further transmits the planned predictive application context relocation to at least one entity involved in the application context relocation for the AC. In certain embodiments, the transceiver 525 further receives at least one cell radio parameter for one or more cells within the predicted route for the UE device, the at least one cell radio parameter used to determine the planned predictive application context relocation for the AC and comprising at least one of a predicted cell change notification for the UE device and a predicted radio bearer utilization.

In one embodiment, the processor 505 further monitors whether conditions for the planned predictive application context relocation for the AC are satisfied in response to the planned predictive application context relocation being executed.

In one embodiment, the processor 505 determines a planned predictive application context relocation change for the AC to the first edge application server of the first edge data network or a third edge application server of a third edge data network, based on the monitoring and the transceiver 525 transmits the planned predictive application context relocation change indication to at least one entity involved in the application context relocation for the AC.

In one embodiment, the transceiver 525 receives a recommendation for the second edge data network, and the processor translates the second edge data network to an optimal edge application server based on a predefined policy.

In various embodiments, the network apparatus 500 is a PACRF network function, described above. In one embodiment, the transceiver 525 receives, at a network function of a mobile wireless communication network, a predicted route for a user equipment (“UE”) device and a processor 505 translates the predicted route for the UE device to at least one service cell that the UE device is expected to traverse.

In such embodiments, the transceiver 525 receives, at the network function, network data analytics parameters for at least one data network associated with the predicted route of the UE and radio measurements describing cell radio conditions for the at least one service cell along the predicted route for the UE device.

In certain embodiments, the processor 505 determines a planned predictive application context relocation for an application client (“AC”) from a first edge application server to a second edge application server based on a trigger action. In certain embodiments, the transceiver transmits the planned predictive application context relocation to at least one entity involved in the application context relocation for the AC.

The memory 510, in one embodiment, is a computer readable storage medium. In some embodiments, the memory 510 includes volatile computer storage media. For example, the memory 510 may include a RAM, including dynamic RAM (“DRAM”), synchronous dynamic RAM (“SDRAM”), and/or static RAM (“SRAM”). In some embodiments, the memory 510 includes non-volatile computer storage media. For example, the memory 510 may include a hard disk drive, a flash memory, or any other suitable non-volatile computer storage device. In some embodiments, the memory 510 includes both volatile and non-volatile computer storage media.

In some embodiments, the memory 510 stores data related to predictive application context relocation. For example, the memory 510 may store parameters, configurations, resource assignments, policies, and the like, as described above. In certain embodiments, the memory 510 also stores program code and related data, such as an operating system or other controller algorithms operating on the network apparatus 500.

The input device 515, in one embodiment, may include any known computer input device including a touch panel, a button, a keyboard, a stylus, a microphone, or the like. In some embodiments, the input device 515 may be integrated with the output device 520, for example, as a touchscreen or similar touch-sensitive display. In some embodiments, the input device 515 includes a touchscreen such that text may be input using a virtual keyboard displayed on the touchscreen and/or by handwriting on the touchscreen. In some embodiments, the input device 515 includes two or more different devices, such as a keyboard and a touch panel.

The output device 520, in one embodiment, is designed to output visual, audible, and/or haptic signals. In some embodiments, the output device 520 includes an electronically controllable display or display device capable of outputting visual data to a user. For example, the output device 520 may include, but is not limited to, an LCD display, an LED display, an OLED display, a projector, or similar display device capable of outputting images, text, or the like to a user. As another, non-limiting, example, the output device 520 may include a wearable display separate from, but communicatively coupled to, the rest of the network apparatus 500, such as a smart watch, smart glasses, a heads-up display, or the like. Further, the output device 520 may be a component of a smart phone, a personal digital assistant, a television, a table computer, a notebook (laptop) computer, a personal computer, a vehicle dashboard, or the like.

In certain embodiments, the output device 520 includes one or more speakers for producing sound. For example, the output device 520 may produce an audible alert or notification (e.g., a beep or chime). In some embodiments, the output device 520 includes one or more haptic devices for producing vibrations, motion, or other haptic feedback. In some embodiments, all, or portions of the output device 520 may be integrated with the input device 515. For example, the input device 515 and output device 520 may form a touchscreen or similar touch-sensitive display. In other embodiments, the output device 520 may be located near the input device 515.

The transceiver 525 includes at least transmitter 530 and at least one receiver 535. One or more transmitters 530 may be used to communicate with the UE, as described herein. Similarly, one or more receivers 535 may be used to communicate with network functions in the NPN, PLMN and/or RAN, as described herein. Although only one transmitter 530 and one receiver 535 are illustrated, the network apparatus 500 may have any suitable number of transmitters 530 and receivers 535. Further, the transmitter(s) 530 and the receiver(s) 535 may be any suitable type of transmitters and receivers.

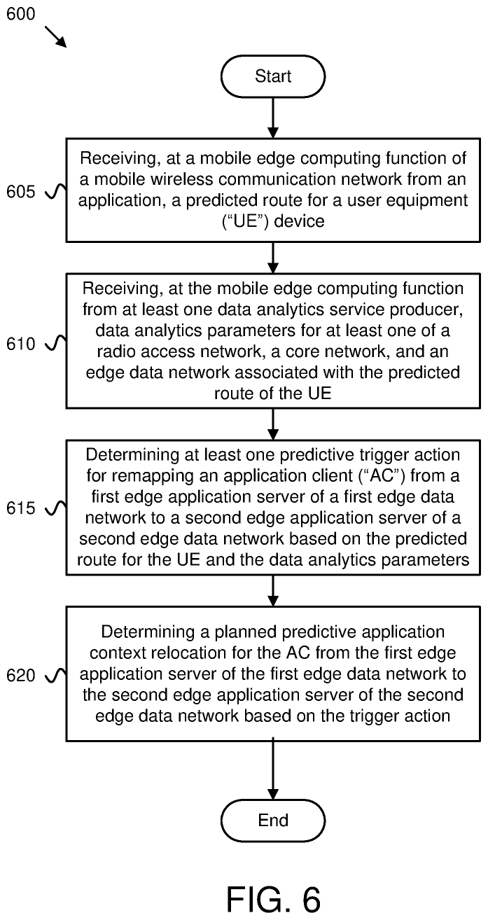

FIG. 6 is a flowchart diagram of a method 600 for predictive application context relocation. The method 600 may be performed by a UE as described herein, for example, the remote unit 105, the UE 205 and/or the user equipment apparatus 400, an edge computing device, a EAS 172, an EES 174, an ECS 176, an EEC 178, and/or other middleware device. In some embodiments, the method 600 may be performed by a processor executing program code, for example, a microcontroller, a microprocessor, a CPU, a GPU, an auxiliary processing unit, a FPGA, or the like.

The method 600, in one embodiment, includes receiving 605, at a mobile edge computing function of a mobile wireless communication network from an application, a predicted route for a user equipment (“UE”) device. The method 600, in one embodiment, includes receiving 610, at the mobile edge computing function from at least one data analytics service producer, data analytics parameters for at least one of a radio access network, a core network, and an edge data network associated with the predicted route of the UE. The method 600, in one embodiment, includes determining 615 at least one predictive trigger action for remapping an application client (“AC”) from a first edge application server of a first edge data network to a second edge application server of a second edge data network based on the predicted route for the UE and the data analytics parameters. The method 600, in one embodiment, includes determining 620 a planned predictive application context relocation for the AC from the first edge application server of the first edge data network to the second edge application server of the second edge data network based on the trigger action. The method 600 ends.

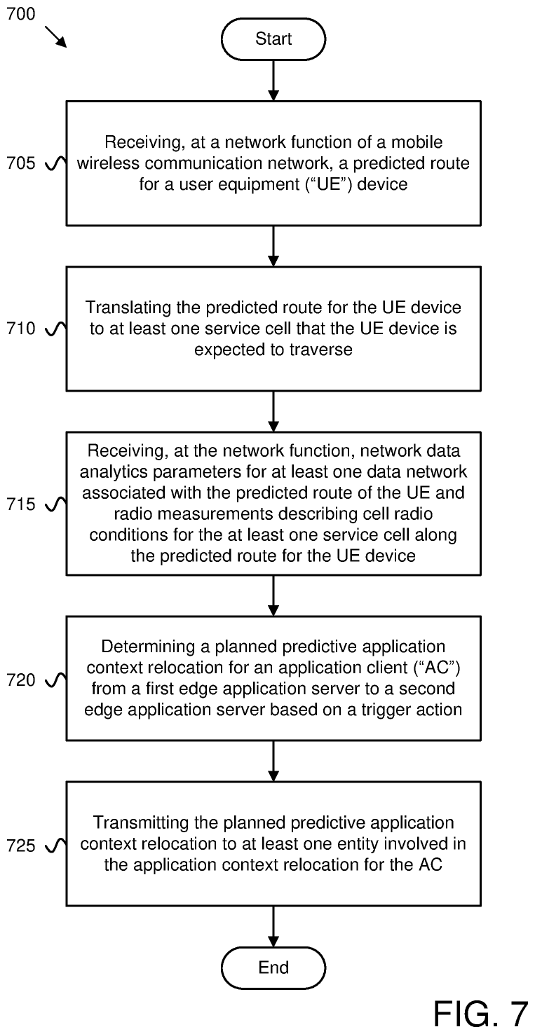

FIG. 7 is a flowchart diagram of a method 700 for predictive application context relocation. The method 700 may be performed by a network device, such as the network equipment apparatus 500, a network function, and/or the like. In some embodiments, the method 700 may be performed by a processor executing program code, for example, a microcontroller, a microprocessor, a CPU, a GPU, an auxiliary processing unit, a FPGA, or the like.

The method 700, in one embodiment, includes receiving 705, at a network function of a mobile wireless communication network, a predicted route for a user equipment (“UE”) device. The method 700, in one embodiment, includes translating 710 the predicted route for the UE device to at least one service cell that the UE device is expected to traverse. The method 700, in one embodiment, includes receiving 715, at the network function, network data analytics parameters for at least one data network associated with the predicted route of the UE and radio measurements describing cell radio conditions for the at least one service cell along the predicted route for the UE device.

The method 700, in one embodiment, includes determining 720 a planned predictive application context relocation for an application client (“AC”) from a first edge application server to a second edge application server based on a trigger action. The method 700, in one embodiment, includes transmitting 725 the planned predictive application context relocation to at least one entity involved in the application context relocation for the AC. The method 700 ends.

A first method is disclosed for predictive application context relocation. The first method may be performed by a UE as described herein, for example, the remote unit 105, the UE 205 and/or the user equipment apparatus 400, an edge computing device, a EAS 172, an EES 174, an ECS 176, an EEC 178, and/or other middleware device. In some embodiments, the first method may be performed by a processor executing program code, for example, a microcontroller, a microprocessor, a CPU, a GPU, an auxiliary processing unit, a FPGA, or the like.

In one embodiment, the first method includes receiving, at a mobile edge computing function of a mobile wireless communication network from an application, a predicted route for a user equipment (“UE”) device. In further embodiments, the first method includes receiving, at the mobile edge computing function from at least one data analytics service producer, data analytics parameters for at least one of a radio access network, a core network, and an edge data network associated with the predicted route of the UE.

In one embodiment, the first method includes determining at least one predictive trigger action for remapping an application client (“AC”) from a first edge application server of a first edge data network to a second edge application server of a second edge data network based on the predicted route for the UE and the data analytics parameters. In certain embodiments, the first method includes determining a planned predictive application context relocation for the AC from the first edge application server of the first edge data network to the second edge application server of the second edge data network based on the trigger action.

In various embodiments, the first method includes configuring a policy for performing the planned predictive application context relocation for the AC, the policy comprising at least one rule for selecting an edge application server and/or an edge data network for remapping the AC. In certain embodiments, the at least one rule is selected from the group comprising selecting the edge application server and/or edge data network that is geographically closer to the UE device and selecting the edge application server and/or edge data network that satisfies quality of service requirements, based on the network data analytics parameters, and at least one of has a load that satisfies a load threshold, is associated with a RAN node that has a load that satisfies the load threshold, services a larger coverage area than other edge data networks, and provides a higher performance than other edge data networks.

In one embodiment, the first method includes transmitting the planned predictive application context relocation to at least one entity involved in the application context relocation for the AC. In one embodiment, the first method includes receiving at least one cell radio parameter for one or more cells within the predicted route for the UE device, the at least one cell radio parameter used to determine the planned predictive application context relocation for the AC and comprising at least one of a predicted cell change notification for the UE device and a predicted radio bearer utilization.

In one embodiment, the planned predictive application context relocation for the AC comprises an expected time frame for when the application context relocation for the AC from the first edge data network to the second edge data network is to occur. In one embodiment, the planned predictive application context relocation for the AC comprises an expiration time for the expected relocation.

In one embodiment, the first method includes monitoring whether conditions for the planned predictive application context relocation for the AC are satisfied in response to the planned predictive application context relocation being executed. In one embodiment, the monitoring comprises one or more of obtaining one or more location reports for the UE device, receiving one or more edge data network performance changes within the predicted route of the UE, receiving one or more edge enabler server availability change reports, receiving one or more performance and/or fault monitoring events from a network management domain, receiving a quality of service (“QoS”)/resource change notification for the mobile wireless communication network within the predicted route of the UE, and receiving an expected or predicted QoS/resource change notification for the UE device.

In one embodiment, the first method includes determining a planned predictive application context relocation change for the AC to the first edge application server of the first edge data network or a third edge application server of a third edge data network, based on the monitoring and transmitting the planned predictive application context relocation change indication to at least one entity involved in the application context relocation for the AC.

In one embodiment, the first method includes receiving a recommendation for the second edge data network and translating the second edge data network to an optimal edge application server based on a predefined policy. In certain embodiments, the predicted route for the UE comprises one or more of a start location, an end location, an intermediate location between the start and the end locations, one or more service cells between the start and end locations, a latitude, a longitude, and an altitude of one or more waypoints between the start and end locations. In one embodiment, the first edge data network and the second edge data network are the same data networks.

A first apparatus is disclosed for predictive application context relocation. The first apparatus may include a UE as described herein, for example, the remote unit 105, the UE 205 and/or the user equipment apparatus 400, an edge computing device, a EAS 172, an EES 174, an ECS 176, an EEC 178, and/or other middleware device. In some embodiments, the first apparatus may include a processor executing program code, for example, a microcontroller, a microprocessor, a CPU, a GPU, an auxiliary processing unit, a FPGA, or the like.

In one embodiment, the first apparatus is a control device that includes a transceiver that receives, at a mobile edge computing function of a mobile wireless communication network from an application, a predicted route for a user equipment (“UE”) device and receives, at the mobile edge computing function from at least one data analytics service producer, data analytics parameters for at least one of a radio access network, a core network, and an edge data network associated with the predicted route of the UE.

In one embodiment, the control device includes a processor that determines at least one predictive trigger action for remapping an application client (“AC”) from a first edge application server of a first edge data network to a second edge application server of a second edge data network based on the predicted route for the UE and the data analytics parameters and determines a planned predictive application context relocation for the AC from the first edge application server of the first edge data network to the second edge application server of the second edge data network based on the trigger action.

In one embodiment, the processor further configures a policy for performing the planned predictive application context relocation for the AC, the policy comprising at least one rule for selecting an edge application server and/or an edge data network for remapping the AC.

In one embodiment, the at least one rule is selected from the group comprising selecting the edge application server and/or edge data network that is geographically closer to the UE device and selecting the edge application server and/or edge data network that satisfies quality of service requirements, based on the network data analytics parameters, and at least one of has a load that satisfies a load threshold, is associated with a RAN node that has a load that satisfies the load threshold, services a larger coverage area than other edge data networks, and provides a higher performance than other edge data networks.

In one embodiment, the transceiver further transmits the planned predictive application context relocation to at least one entity involved in the application context relocation for the AC. In certain embodiments, the transceiver further receives at least one cell radio parameter for one or more cells within the predicted route for the UE device, the at least one cell radio parameter used to determine the planned predictive application context relocation for the AC and comprising at least one of a predicted cell change notification for the UE device and a predicted radio bearer utilization.

In one embodiment, the planned predictive application context relocation for the AC comprises an expected time frame for when the application context relocation for the AC from the first edge data network to the second edge data network is to occur. In certain embodiments, the planned predictive application context relocation for the AC comprises an expiration time for the expected relocation.

In one embodiment, the processor further monitors whether conditions for the planned predictive application context relocation for the AC are satisfied in response to the planned predictive application context relocation being executed. In various embodiments, the monitoring comprises one or more of obtaining one or more location reports for the UE device, receiving one or more edge data network performance changes within the predicted route of the UE, receiving one or more edge enabler server availability change reports, receiving one or more performance and/or fault monitoring events from a network management domain, receiving a quality of service (“QoS”)/resource change notification for the mobile wireless communication network within the predicted route of the UE, and receiving an expected or predicted QoS/resource change notification for the UE device.

In one embodiment, the processor determines a planned predictive application context relocation change for the AC to the first edge application server of the first edge data network or a third edge application server of a third edge data network, based on the monitoring and the transceiver transmits the planned predictive application context relocation change indication to at least one entity involved in the application context relocation for the AC.

In one embodiment, the transceiver receives a recommendation for the second edge data network, and the processor translates the second edge data network to an optimal edge application server based on a predefined policy. In one embodiment, the predicted route for the UE comprises one or more of a start location, an end location, an intermediate location between the start and the end locations, one or more service cells between the start and end locations, a latitude, a longitude, and an altitude of one or more waypoints between the start and end locations. In one embodiment, the first edge data network and the second edge data network are the same data networks.

A second method is disclosed for predictive application context relocation. The second method may be performed by a network device, such as the network equipment apparatus 500, a network function, and/or the like. In some embodiments, the second method may be performed by a processor executing program code, for example, a microcontroller, a microprocessor, a CPU, a GPU, an auxiliary processing unit, a FPGA, or the like.

In one embodiment, the second method includes receiving, at a network function of a mobile wireless communication network, a predicted route for a user equipment (“UE”) device, translating the predicted route for the UE device to at least one service cell that the UE device is expected to traverse, receiving, at the network function, network data analytics parameters for at least one data network associated with the predicted route of the UE and radio measurements describing cell radio conditions for the at least one service cell along the predicted route for the UE device, determining a planned predictive application context relocation for an application client (“AC”) from a first edge application server to a second edge application server based on a trigger action, and transmitting the planned predictive application context relocation to at least one entity involved in the application context relocation for the AC.

A second apparatus is disclosed for predictive application context relocation. The second apparatus may include a network device, such as the network equipment apparatus 500, a network function, and/or the like. In some embodiments, the second apparatus may include by a processor executing program code, for example, a microcontroller, a microprocessor, a CPU, a GPU, an auxiliary processing unit, a FPGA, or the like.

In one embodiment, the second apparatus is a control device that includes a transceiver that receives, at a network function of a mobile wireless communication network, a predicted route for a user equipment (“UE”) device and a processor that translates the predicted route for the UE device to at least one service cell that the UE device is expected to traverse.

In one embodiment, the transceiver receives, at the network function, network data analytics parameters for at least one data network associated with the predicted route of the UE and radio measurements describing cell radio conditions for the at least one service cell along the predicted route for the UE device.

In certain embodiments, the processor determines a planned predictive application context relocation for an application client (“AC”) from a first edge application server to a second edge application server based on a trigger action. In certain embodiments, the transceiver transmits the planned predictive application context relocation to at least one entity involved in the application context relocation for the AC.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A network equipment (NE) for wireless communication, comprising:
at least one memory; and
at least one processor coupled with the at least one memory and configured to cause the NE to:
receive a predicted route for a user equipment (“UE”);
receive one or more data analytics parameters for at least one of a radio access network (RAN), a core network, or an edge data network associated with the predicted route of the UE;
determine at least one trigger action for remapping an application client from a first edge application server of a first edge data network to a second edge application server of a second edge data network based on the predicted route for the UE and the one or more data analytics parameters; and
determine an application context relocation for the application client based on the at least one trigger action.

2. The NE of claim 1, wherein the at least one processor is configured to cause the NE to configure a policy for performing the application context relocation for the application client, the policy comprising at least one rule for selecting an edge application server or an edge data network for remapping the application client.

3. The NE of claim 2, wherein the at least one rule comprises:
selecting the edge application server or edge data network that is geographically closer to the UE;
selecting the edge application server or edge data network that satisfies quality of service requirements, based on the one or more data analytics parameters, and at least one of:
has a load that satisfies a load threshold;
is associated with a RAN node that has a load that satisfies the load threshold;
services a larger coverage area than other edge data networks; and
provides a higher performance than other edge data networks;
or a combination thereof.

4. The NE of claim 1, wherein the at least one processor is configured to cause the NE to transmit the application context relocation to at least one entity associated with the application context relocation for the application client.

5. The NE of claim 1, wherein the at least one processor is configured to cause the NE to receive at least one cell radio parameter for one or more cells within the predicted route for the UE, the at least one cell radio parameter used to determine the application context relocation for the AC application client and comprising a predicted cell change notification for the UE, a predicted radio bearer utilization, or a combination thereof.

6. The NE of claim 1, wherein the application context relocation for the application client comprises an expected time frame for when the application context relocation for the application client from the first edge data network to the second edge data network is to occur.

7. The NE of claim 1, wherein the application context relocation for the application client comprises an expiration time for the expected relocation.

8. The NE of claim 1, wherein the at least one processor is configured to cause the NE to monitor whether conditions for the application context relocation for the application client are satisfied in response to the application context relocation being executed.

9. The NE of claim 8, wherein monitoring comprises obtaining one or more location reports for the UE, receiving one or more edge data network performance changes within the predicted route of the UE, receiving one or more edge enabler server availability change reports, receiving one or more performance or fault monitoring events from a network management domain, receiving a quality of service (“QoS”) or resource change notification for the predicted route of the UE, receiving an expected or predicted QoS or resource change notification for the UE, or a combination thereof.

10. The NE of claim 8, wherein the at least one processor is configured to cause the NE to:
determine an application context relocation change for the application client to the first edge application server of the first edge data network or a third edge application server of a third edge data network, based on the monitoring; and
transmit the application context relocation change indication to at least one entity involved in the application context relocation for the application client.

11. The NE of claim 1, wherein the at least one processor is configured to cause the NE to:
receive a recommendation for the second edge data network; and
translate the second edge data network to an optimal edge application server based on a predefined policy.

12. The NE of claim 1, wherein the predicted route for the UE comprises a start location, an end location, an intermediate location between the start and the end locations, one or more service cells between the start and end locations, a latitude, a longitude, an altitude of one or more waypoints between the start and end locations, or a combination thereof.

13. The NE of claim 1, wherein the first edge data network and the second edge data network are the same data network.

14. A method performed by a network equipment (NE), the method comprising:
receiving a predicted route for a user equipment (“UE”);
receiving one or more data analytics parameters for at least one of a radio access network (RAN), a core network, or an edge data network associated with the predicted route of the UE;
determining at least one trigger action for remapping an application client from a first edge application server of a first edge data network to a second edge application server of a second edge data network based on the predicted route for the UE and the one or more data analytics parameters; and
determining an application context relocation for the application client based on the at least one trigger action.

15. A network equipment (NE) for wireless communication, comprising:
at least one memory; and
at least one processor coupled with the at least one memory and configured to cause the NE to:
receive, a predicted route for a user equipment (“UE”);
translate the predicted route for the UE to at least one service cell that the UE is expected to traverse;
receive one or more data analytics parameters for at least one data network associated with the predicted route of the UE and one or more radio measurements describing cell radio conditions for the at least one service cell along the predicted route for the UE;
determine an application context relocation for an application client from a first edge application server to a second edge application server based on a trigger action; and
transmit the application context relocation to at least one entity involved in the application context relocation for the application client.

16. A processor for wireless communication, comprising:
at least one controller coupled with at least one memory and configured to cause the processor to:
receive a predicted route for a user equipment (UE);
receive one or more data analytics parameters for at least one of a radio access network (RAN), a core network, or an edge data network associated with the predicted route of the UE;
determine at least one trigger action for remapping an application client from a first edge application server of a first edge data network to a second edge application server of a second edge data network based on the predicted route for the UE and the one or more data analytics parameters; and
determine an application context relocation for the application client based on the at least one trigger action.

17. The processor of claim 16, wherein the at least one controller is configured to cause the processor to configure a policy for performing the application context relocation for the application client, the policy comprising at least one rule for selecting an edge application server or an edge data network for remapping the application client.

18. The processor of claim 17, wherein the at least one rule comprises:
selecting the edge application server or edge data network that is geographically closer to the UE;
selecting the edge application server or edge data network that satisfies quality of service requirements, based on the one or more data analytics parameters, and at least one of:
has a load that satisfies a load threshold;
is associated with a RAN node that has a load that satisfies the load threshold;
services a larger coverage area than other edge data networks; and
provides a higher performance than other edge data networks;
or a combination thereof.

19. The processor of claim 16, wherein the at least one controller is configured to cause the processor to transmit the application context relocation to at least one entity associated with the application context relocation for the application client.

20. The processor of claim 16, wherein the at least one controller is configured to cause the processor to receive at least one cell radio parameter for one or more cells within the predicted route for the UE, the at least one cell radio parameter used to determine the application context relocation for the application client and comprising a predicted cell change notification for the UE, a predicted radio bearer utilization, or a combination thereof.
